(19) United States
(12) Patent Application Publication
(10) Pub. No.: US 2005/0063766 A1
(43) Pub. Date: Mar. 24, 2005

(54) Applicator pen

(75) Inventors: Sou Y. Chen, Taipei (TW); Jun Chung, Guan Don (CN)

Correspondence Address: DARBY & DARBY P.C., P. O. BOX 5257, NEW YORK, NY, 10150-5257, US

(73) Assignee: FRH Development, Inc.

(21) Appl. No.: 10/870,552

(22) Filed: Jun. 16, 2004

Related U.S. Application Data
(60) Provisional application No. 60/480,142, filed on Jun. 20, 2003.

(51) Int. Cl. B43K 5/06

(52) U.S. Cl. 401/179; 401/176

(57) ABSTRACT

An applicator pen is provided for dispensing material, such as cosmetics like lipstick, eye shadow, etc. The applicator pen includes a body including a space for storing the material to be dispensed and an applicator assembly coupled to one end of the body for dispensing a prescribed amount of the material. The applicator pen also includes a drive mechanism interacting with the stored material for causing the prescribed amount of material to be dispensed through the applicator assembly. The drive mechanism including a drive rod that has a number of teeth formed therealong. A button assembly of the applicator pen is coupled to another end of the body and the drive mechanism. The button assembly is positionable between a rest position and an engaged position where the drive rod is ratcheted an incremental distance resulting in the stored material being directed towards the applicator assembly where the prescribed amount of material is dispensed therethrough.

### CROSS-REFERENCE TO RELATED APPLICATION

This application claims the benefit of U.S. patent application Ser. No. 60/480,142, filed Jun. 20, 2003, which is hereby incorporated by reference in its entirety.

### TECHNICAL FIELD

The present invention relates to applicators for dispersing a compound, such as a cosmetic, and more particularly, to an applicator that has a ratcheting mechanism for advancing the compound within the applicator and dispersing it to a consumer.

### BACKGROUND

Applicator devices are widely used to dispense a product that is stored within a compartment of the applicator. For example, one industry that extensively uses applicators is the cosmetic industry where applicators are used to dispense cosmetic products, such as lipstick, eye shadow or liner, etc. Most of the applicator devices use a conventional dispensing mechanism that is of a screw type in that the user simply rotates an end cap member to cause product to be advanced through the body and discharged out from the other end.

There are a number of disadvantages that are associated with these screw type applicators. For example, the applicators are cumbersome to use since they require the user to use two hands to hold and operate the applicator. One hand is needed to physically hold the applicator while the other hand is used to manipulate (i.e., rotate) the end cap member so as to cause advancement of a drive member within the body that results in product being discharged from the other end of the applicator. Many times, the use of two hands is difficult as the user might only have one hand free given the circumstances. In addition, these screw type applicators require multiple priming steps to be taken to initially prime the applicator. In other words, the user is first required to rotated the end cap member a number of revolutions in order to prime the applicator and finally discharge the product. Multiple revolutions can cause to frustration and fatigue. Also, rotation of the end cap member results in variable displacement of product and therefore it is hard to replicate the same dispensing action successively. For example, the user may rotate the end cap member too great a distance resulting in excessive product being dispensed and conversely, the user may rotate the end cap member only a slight distance by accident that results in not enough product being dispensed.

What has heretofore not been available is an improved applicator pen that overcomes the above disadvantages.

### SUMMARY

An applicator pen is provided for dispensing material, such as cosmetics like lipstick, eye shadow, etc. The applicator pen includes a body including a space for storing the material to be dispensed and an applicator assembly coupled to one end of the body for dispensing a prescribed amount of the material. The applicator pen also includes a drive mechanism interacting with the stored material for causing the prescribed amount of material to be dispensed through the applicator assembly. The drive mechanism including a drive rod that has a number of teeth formed therealong. A button assembly of the applicator pen is coupled to another end of the body and the drive mechanism. The button assembly is positionable between a rest position and an engaged position where the drive rod is ratcheted an incremental distance resulting in the stored material being directed towards the applicator assembly where the prescribed amount of material is dispensed therethrough. The ratcheting action of the drive rod is translated into an incremental movement of the drive rod and the displacement of the prescribed amount (metered amount) of material from the storage space in the body. This permits the user to dispense the product in a more controlled manner and product waste is reduced as a result of the present dispensing mechanism.

In addition, the present applicator pen can be held and operated using a single hand as opposed to conventional applicators that are cumbersome to operate since they require one hand for holding the applicator and a second hand for rotating the screw bottom member to dispense product. In addition, the present applicator pen is easy to prime since it requires less priming action and the pressing of a button a number of times successively is generally an action that is easy for the user to partake prior to the first use.

Further aspects and features of the exemplary actuator and method of manufacture thereof can be appreciated from the appended Figures and accompanying written description.

### BRIEF DESCRIPTION OF THE DRAWING FIGURES

FIG. 1 is a cross-sectional view of an exemplary applicator pen according to a first embodiment;

FIG. 2 is a cross-sectional view of a body of the applicator pen of FIG. 1;

FIG. 3 is a cross-sectional view taken along the line 3-3 of FIG. 2;

FIG. 4 is a cross-sectional view of an inner applicator body that forms a part of an applicator assembly of FIG. 1;

FIG. 5 is a cross-sectional view of an applicator;

FIG. 6 is a cross-sectional view of a collar that surrounds the applicator of FIG. 5;

FIG. 7 is a cross-sectional view of a cap for placement over the applicator;

FIG. 8 is a side elevation view of a drive rod of the applicator pen of FIG. 1;

FIG. 9 is a perspective view of a plunger that mates with the drive rod of FIG. 8;

FIG. 10 is a cross-sectional view of the plunger of FIG. 9;

FIG. 11 is a perspective view of a fix button;

FIG. 12 is a cross-sectional view of the fix button of FIG. 11;

FIG. 13 is a perspective view of a first tooth engaging member;

FIG. 14 is a cross-sectional view of a press plug;

FIG. 14A is another cross-sectional view of the press plug;

FIG. 15 is a perspective view of a second tooth engaging member;

FIG. 16 is a side elevation view of a first spring that applies a biasing force to the press plug; FIG. 17 is a cross-sectional view of a lock plug that engages the body of the applicator;

FIG. 18 is a cross-sectional view of a button;

FIG. 19 is an enlarged partial cross-sectional view of the press plug and fix button showing the interaction therebetween; and

FIG. 20 is a cross-sectional view of an applicator pen according to a second embodiment.

### DETAILED DESCRIPTION OF PREFERRED EMBODIMENTS

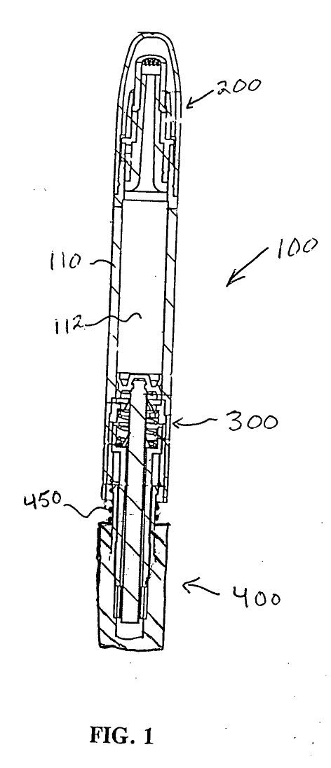

FIG. 1 is a cross-sectional view of an applicator pen 100 according to a first embodiment. The applicator pen 100 is formed of a number of different sub-assemblies that are then combined in an engaging manner to form the applicator pen 100. More specifically, the applicator pen 100 includes a body 110 and an applicator assembly 200 that serves to restrict and disperse an applicator material 112 that is stored within the body 110. The applicator pen 100 also includes a drive mechanism 300 for advancing the applicator material 112 within the body 110 such that it is introduced into and dispersed through the applicator assembly 200 to the consumer. The drive mechanism 300 is coupled to a button assembly 400 that permits the consumer to simply advance the applicator material 112 an incremental amount within the body 110 upon manipulation of the button assembly 400, e.g., a press and release action of the button assembly 400.

While the applicator material 112 can be any number of different types of materials, it will be appreciated that one exemplary use of the applicator 100 is as a cosmetic applicator and therefore, in this particular use, the applicator material 112 is in the form of a cosmetic product. For example, the applicator material 112 can in the form of conventional make-up, such as an eye shadow or liner, lipstick, other facial products, etc. The applicator material 112 is typically a viscous material, such as a liquid, gel or other material that has some flow properties.

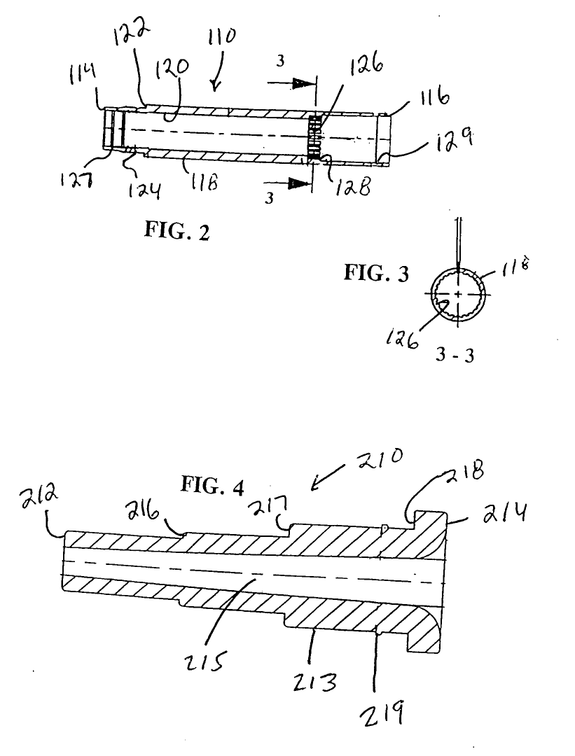

Referring to FIGS. 1-3, the body 110 of the applicator pen 100 is illustrated in more detail. The body 110 is an elongated body that has a first end 114 and an opposing second end 116. The exemplary body 110 is a generally tubular member that is open at the first and second ends 114, 116 and includes an outer surface 118 and an inner surface 120. At and near the first end 114, the body 110 has a stepped construction and more specifically, a first outer shoulder 122 is formed where the diameter of the body 110 is reduced compared to the diameter of the body 110 along a substantial length thereof and to the second end 116. Along this area of reduced diameter, the outer surface 118 has at least one radial groove or channel 127 formed therein between the first outer shoulder 122 and the first end 114. The groove 127 serves as a means for engaging and retaining other components of the applicator 100 as will be described below.

The inner surface 120 of the body 110 has a locating and retaining feature 126 formed therein and more specifically, the inner surface 120 has a number of radially arranged ribs 126 formed therein at a location between the first and second ends 114, 116, preferably closer to the second end 116. The cross-sectional view of FIG. 3 illustrates the inner ribs 126. The ribs 126 are longitudinally orientated along the length of the body 110. Between adjacent ribs 126, a space is formed having a predetermined width for receiving a complementary feature of another component as will be described. The inner surface 120 also includes a first inner shoulder 128 formed therein adjacent one end of the ribs 126. In the exemplary embodiment, the first inner shoulder 128 is formed adjacent the end of the ribs 126 that is closest to the second end 116 of the body 110 such that the inner diameter of the body 110 at the second end 116 is greater than the inner diameter of the body 110 at a location above the first inner shoulder 128. The inner surface 120 also includes an annular grooves 124 formed proximate the first end 114 above the first outer shoulder 122. The groove 124 serves as a means for engaging and retaining other components of the applicator 100 as will be described below. In addition, an annular groove 129 is formed along the inner surface 120 near the second end 116.

FIGS. 1-7 illustrate one exemplary applicator assembly 200 that acts to disperse the applicator material 112 to the consumer. The applicator assembly 200 includes a number of different parts that complement and engage each other to direct the material 112 to the consumer and more specifically, the applicator assembly 200 includes an inner applicator body 210 and an applicator 220. The inner applicator body 210 is shown in FIG. 4 and is an elongated body that has a first end 212 and an opposing second end 214 with a through bore 215 formed therethrough from the first end 212 to the second end 214. The bore 215 preferably does not contain the same diameter but rather its diameter changes over the length thereof. In other words, the exemplary bore 215 has an inward tapered construction in that its diameter is greatest at the second end 214 and least at the first end 212. Similarly, an outer surface 213 of the body 210 is not uniform but rather it is of a stepped construction which is defined by a number of shoulders (annular shoulders). The illustrated body 210 has a first shoulder 216, a second shoulder 217, and a third shoulder 218 formed near the second end 214. An annular ring 219 is formed along the outer surface 213 between the second and third shoulders 217, 218.

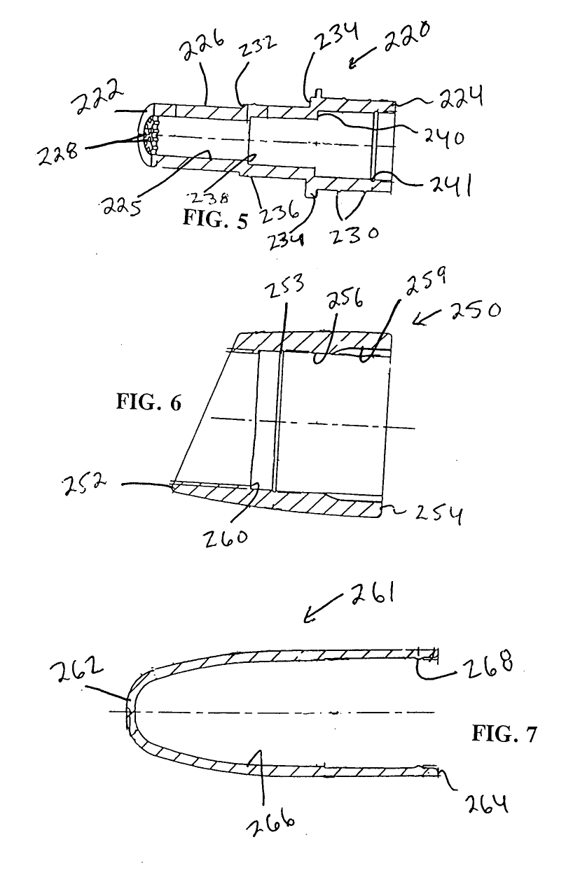

FIG. 5 illustrates one exemplary applicator 220 that has a first end 222 and an opposing second end 224 as well as an inner surface 225, and an outer surface 226. The applicator 220 is essentially a hollow member with the second end 224 being open and the first end 222 having a plurality of ports or openings 228 that provide communication with a cavity formed within the body 210. The first end 222 in which the openings 228 are formed is preferably a beveled end. Both the inner surface 225 and the outer surface 226 have a stepped construction to facilitate mating of the applicator 220 with other components. For example, the outer surface 226 can include a plurality of annular rings 230 formed proximate the second end 224 as well as a first outer shoulder 232 and a second outer shoulder 234. Another annular ring 236 is preferably formed between the two shoulders 232, 234 closer to the shoulder 232. Similarly, the inner surface 225 has a number of shoulders formed therein so that the area of the cavity formed within the applicator 220 decreases along its length from the second end 224 toward the first end 222. For example, the inner surface 225 includes a first inner shoulder 238 closer to the first end 222 and a second inner shoulder 240 closer to the second end 224.

The inner applicator body 210 is configured so that it can be disposed within the inner cavity of the applicator 220. More specifically, the inner applicator body 210 is disposed in the inner cavity so that the first shoulder 216 seats against the first inner shoulder 238 and the second shoulder 217 seats against the second inner shoulder 240. The first and second inner shoulders 238, 240 thus act as stops that restrict the degree of travel of the inner applicator body 210 within the inner cavity of the applicator 220. When the inner applicator body 210 is fully seated within the applicator 220, the third shoulder 218 seats against the second end 224 with the annular ring 219 seating within a complementary annular groove 241 to further locate and interlock the two components in a snap fit manner. The length of the inner applicator body 210 is such that when it engages the applicator 220, the first end 212 does not contact the partially closed first end 222 of the applicator 220 but rather is spaced slightly therefrom.

The inner applicator body 210 thus serves to restrict and reduce the amount of applicator material 112 that is contained within the applicator 200 during use of the applicator pen 100 and storage thereof between applications. It will be appreciated that as the applicator material 112 is advanced within the body 110 due to activation of the drive mechanism 300, the applicator material 112 is pushed into the bore 215 of the applicator body 210 and driven toward the first end 212 where it is discharged through the ports 228 formed at the first end 222 of the applicator 220.

The applicator assembly 200 also includes a collar 250 that is best shown in FIG. 6. The collar 250 mates with the applicator 220 and acts more as an aesthetic member that obscures/hides the underlying components of the applicator assembly 200 and the interlocking interfaces thereof. One exemplary collar 250 is an essentially hollow member that has an open beveled first end 252 that is complementary to the beveled nature of the first end 222 of the applicator 220 and an opposing second end 254 that is also open. The collar 250 is also slightly tapered inward from the second end 254 to the first end 252 to complement the tapered constructions of the other components. An inner surface 256 of the collar 250 has a number of features formed therein to permit the collar 250 to snap-lockingly engage the applicator 220. For example, the inner surface 256 has an annular cut 259 formed near and extending to the second end 254 for orientating the beveled end 252 at a common angle relative to the end 222 (e.g., the cuts 259 receive tabs or the like which are formed on the outer surface of the applicator 220 and act as a key to ensure proper orientation). In addition, an inner shoulder 260 seats against the outer shoulder 232 of the applicator 220, while the annular ring 236 of the applicator is received within an annular groove 253 formed along the inner surface 256 of the collar 250. When the collar 250 is releasably but securely coupled to the applicator 220, the second end 254 seats against the shoulder 234 of the applicator 220. The collar 250 is sized so that an upper section of the applicator 220 protrudes beyond the first end 252 of the collar 250.

The applicator assembly 200 also includes a cap 261 that protects the first end 222 of the applicator 220. The cap 261 has a conventional design including a dome shaped closed first end 262 and an open second end 264. An inner surface 266 of the cap 261 includes an annular ring (protrusion) 268 that acts as a male locking part that mates with the complementary groove 124 formed along the outer surface 120 of the body 110. In the locked position, the second end 264 of the cap 261 seats against the first outer shoulder 122, which thus acts as a stop for the cap 261.

The applicator assembly 200 releasably interlocks with the body 110 of the applicator 100. More specifically, the applicator 220 interlockingly engages the body 110 with the first end 114 of the body 110 seating against (underneath) the second outer shoulder 234 of the applicator 220. The interlocking engagement between the applicator 220 and the body 110 is also caused by the reception of the plurality of annular rings 230 within the complementary annular grooves 127 formed on the inner surface 120 of the body 110. In this interlocked position, the second end 214 of the inner applicator body 210 likewise seats against the inner surface 120 of the body 110. The applicator material 112 is held within the body 110 at a location below the applicator assembly 200 so that operation of the applicator pen 100 causes the applicator material 112 to be driven upwards within the body 110 and into the inner applicator body 210.

The drive mechanism 300 is another assembly of the applicator pen 100 and the mechanism 300 generally serves to advance the applicator material 112 in a controlled manner so that a predetermined amount of applicator material 112 is discharged through the ports 228 to the consumer as a result of each operation action by the consumer. According to one exemplary embodiment, the drive mechanism 300 includes a drive rod 310 that is illustrated in detail in FIG. 8. The drive rod 310 is an elongated screw-like member that has a first end 312 and an opposing second end 314 and in the illustrated embodiment, the drive rod 310 has an annular shape. An outer surface of the drive rod 310 has a number of teeth 316 formed as a part thereof. The teeth 316 are formed along the length of the drive rod 310 and are formed one on top of another such that the teeth 316 are parallel to one another. In cross-section, the teeth 316 appear as serrated edges and they function as ratcheting teeth. In other words, the teeth 316 form horizontal threads as opposed to the conventional pitched threads that are formed along a conventional drive screw or the like.

Preferably, the drive rod 310 is formed of a metal material, such as aluminum. This is in contrast to conventional drive rods or screws that were formed entirely of a plastic material; however, this type of construction has a number of limitations that are all overcome by the current drive rod 310. Molding a plastic material to form teeth in itself has limitations since the height of the teeth is limited by molding specifications. In contrast, the height of the teeth 316 can be reduced in the present design since the entire drive rod 310 is formed of metal which permits a reduction in tooth height as a result of more precise techniques to control the formation and height of the teeth 316. In one exemplary embodiment, the height of one tooth 316 is about 0.45 mm. A reduction in the height of the tooth 316 is important since the height of the tooth 316 defines the distance which the drive rod 310 is driven upon each operation action taken by the consumer as will be described hereinafter. Thus, a reduction in the height of the tooth 316 permits less applicator material 112 to be discharged from the applicator 100, thereby permitting the consumer to use only the amount desired instead of an excessive amount being discharged.

The first end 312 of the drive rod 310 includes a feature formed as a part thereof to permit the drive rod 310 to be securely coupled to another component. More specifically, the first end 312 has formed thereat above the uppermost tooth 316 a stepped construction that terminates in an annular flange section 317 at the first end 312. Immediately above the uppermost tooth 316 is a disk shaped member 319 that has a diameter less than a diameter of the uppermost tooth 316 and therefore an annular shoulder 320 is formed between the disk shaped member 319 and the uppermost tooth 316. Between the disk shaped member 319 and the annular flange 317 is an annular intermediate section 322 that has a diameter that is less than a diameter of each of the annular flange 317 and the disk shaped member 319.

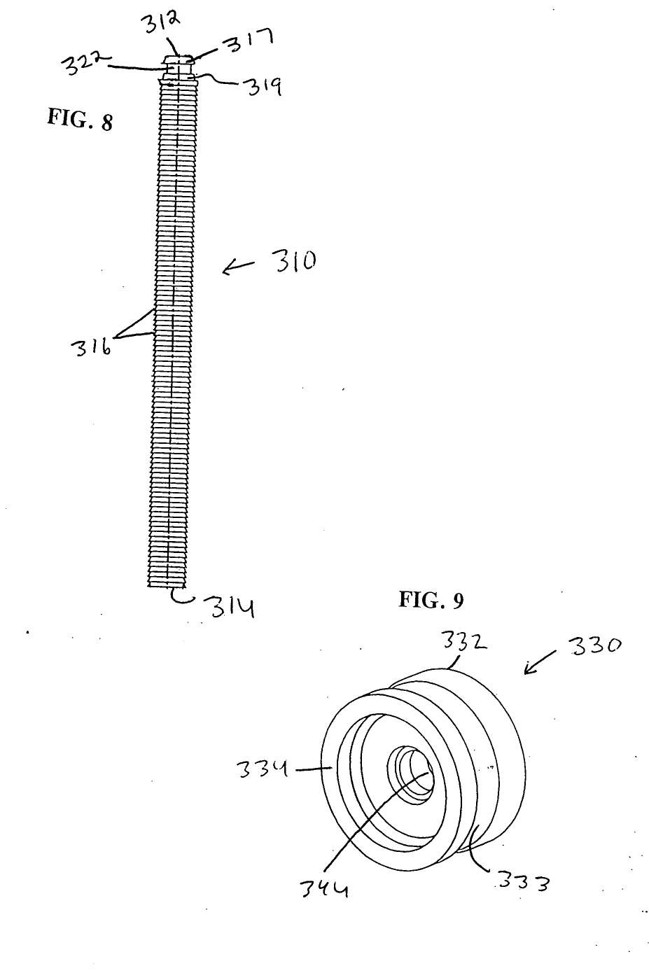

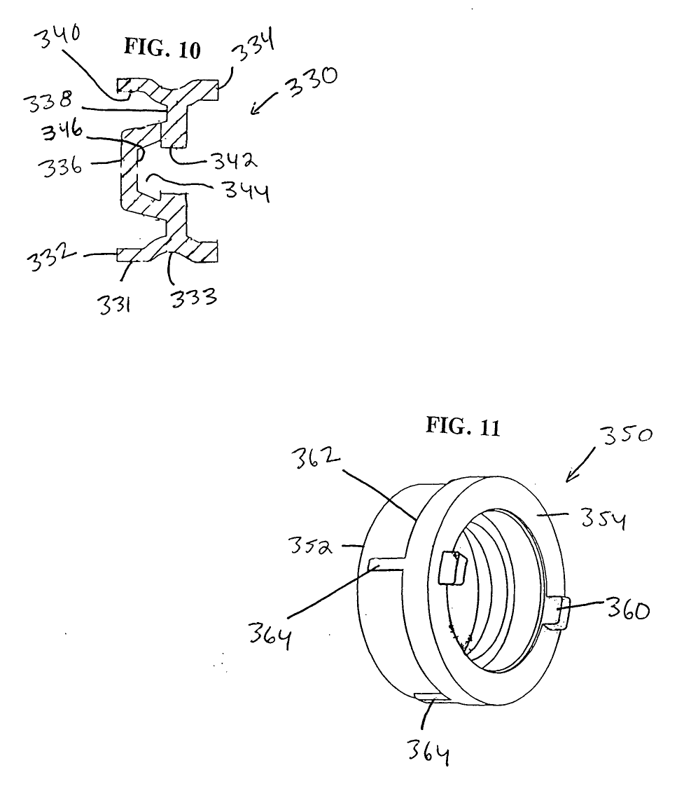

The drive mechanism 300 also includes a plunger 330 that is coupled to the first end 312 of the drive rod 310 and is best illustrated in FIGS. 9 and 10. The plunger 330 has a closed first end 332 and an opposing open second end 334. The plunger 330 has a contoured outer surface 331 that includes an annular groove or channel 333 formed therein at approximately the center section of the plunger 330. The plunger 330 has a boss or the like 336 that extends up to the first end 332 and an annular recessed ring shaped platform or floor 338 is formed at the bottom of the boss 336 between the boss 336 and an annular vertical wall 340 that surrounds the boss 336 and platform 338 and extends up to the first end 332.

An underside of both the boss 336 and the platform 338 are constructed so that they receive and interlocking engage the first end 312 of the drive rod 310. More specifically, the boss 336 is essentially hollow and includes an annular ring 342 that protrudes inwardly from the wall defining the boss 336. The annular ring 342 defines a space 344 that is formed above the annular ring 342 and extends to a horizontal wall 346 that is an upper wall of the boss 336. The space 344 has a shape that is complementary to the annular flange section 317 so that this section is frictionally received and retained within the space 344 and the distance between the annular ring 342 frictionally receives the intermediate section 322. The disk shaped member 319 seats against the inner boss wall below the annular ring 342. In other words, the first end 312 of the drive rod 310 is securely coupled to the plunger 330 by producing a frictional fit therebetween by inserting the flange section 317 into the space 344.

The outer diameter of the plunger 330 is approximately equal to or slightly greater than an inner diameter of the body 110 so that a frictional, sealed interface results between the plunger 330 and the inner wall of the body 110. The plunger 330 is preferably formed of a resilient, flexible material, such as a polymeric material, e.g., polyethylene. The plunger 330 frictionally engages the inner wall of the body 110 in such a way that the plunger 330 can support the drive rod 310 without the plunger 330 sliding or moving along the inner wall of the body 110. The drive rod 310 thus extends downwardly from the plunger 330 when the plunger 330 is held in place along the inner wall. It will be appreciated that the plunger 330 can move along the inner wall of the body 110 when a force is applied to the underside of the plunger 330. The applicator material 112 is stored within the body 110 immediately above the plunger 330. The sealing characteristics of the plunger 330 permit the plunger 330 to act as a wiper in that it cleans the inner wall of the applicator material 112 as the plunger 330 is advanced therealong. As the drive mechanism 300 is operated and the drive rod 310 is driven, the plunger 330 is advanced along the inner wall of the body 110 toward the first end 114 thereof.

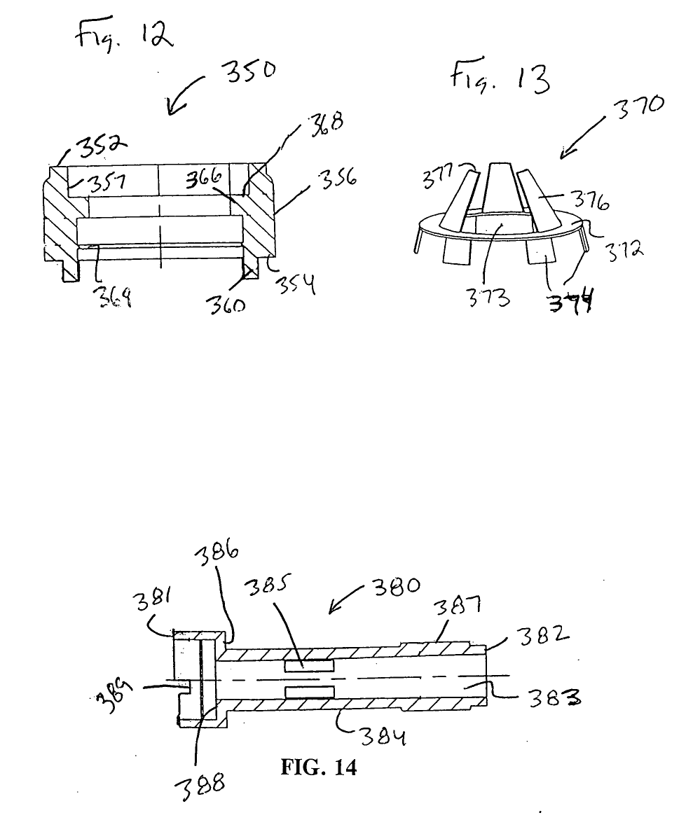

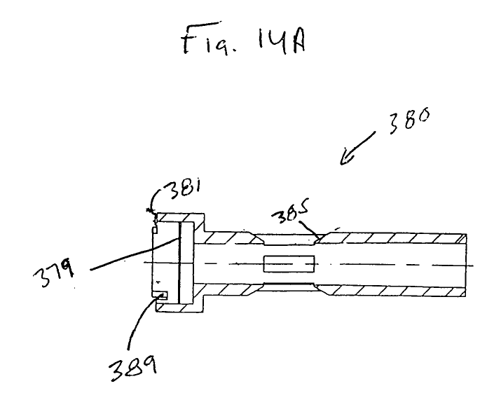

The drive mechanism 300 also includes a fix button 350 that is best shown in FIGS. 11 and 12. The fix button 350 is an annular member that is shaped and sized to be received between the inner wall of the body 110. The fix button 350 has an open first end 352 and an open second end 354 along with an outer surface 356 and an inner surface 357. FIG. 12 is a cross-sectional view that illustrates a pair of optional locking tabs 360 that are formed at the second end 354. In the illustrated embodiment, the locking tabs 360 are square or rectangular shaped members that extend a predetermined distance from the second end 354.

A body of the fix button 350 can be thought of as having two sections, namely a first section that extends to the first end 352 and is of reduced diameter and a second section that extends to the second end 354 and is of greater diameter. An outer shoulder 362 is formed between the two sections. In addition, the outer surface 356 of the fix button 350 has a number of longitudinal ribs 364 (e.g., 4) formed radially therearound such that they extend upwardly from the outer shoulder 362. For example, the exemplary fix button 350 has four longitudinal ribs 364 that are evenly spaced around the outer surface 356 of the fix button 350. Preferably, the top edge of each rib 364 is a chamfered or rounded top edge so that the rib 364 more smoothly transitions into the upper first section of the fix button. The chamfered top edges permit the fix button 350 to more easily seat within the body 110 between the ribs 126. An annular ring or protrusion 366 is formed and defines a first shoulder 368. Below the annular ring 366 proximate the second end 354, the inner surface 357 includes at least one annular flange 369.

The fix button 350 is placed into the body 110 with its first end 352 facing the first end 114 of the body 110 and the longitudinal ribs 364 have a width that permits them to be disposed between adjacent ribs 126. In other words, the interaction between the ribs 364, 126 serves to locate the fix button 350 relative to the body 110. The first inner shoulder 128 also serves to locate the fix button 350 relative to the body 110 and in fact it acts as a stop that limits the travel of the fix button 350 within the body 110 toward the first end 114 thereof. When the fix button 350 is inserted into the body 110, the outer shoulder 362 seats against the first inner shoulder 128 of the body 110, while the ribs 126, 364 mesh with one another. The interfacing between the outer shoulder 362 and first inner shoulder 128 locates the fix button 350 within the body 110. The open nature of the fix button 350 permits the drive rod 310 to extend therethrough. In addition, the annular ring or protrusion 366 and more particularly, the first shoulder 368 thereof, limits the travel of the plunger 330 and more specifically, the second end 334 of the plunger 330 will contact the first shoulder 368 if the plunger 330 is excessively directed towards the second end 116 of the body 110.

FIG. 13 illustrates a first tooth engaging member 370 that is coupled to the fix button 350 and engages the teeth 316 of the drive rod 310. One exemplary first tooth engaging member 370 includes a ring-shaped base 372 that has a central opening 373 formed therethrough and includes a plurality of retaining tabs 374 that extend from a peripheral edge of a bottom face of the base 372. The tabs 374 are radially spaced around the peripheral edge and can have any number of different shapes. Exemplary shapes include rectangular or square shaped. The first tooth engaging member 370 can be formed from a number of different materials; however, the first tooth engaging member 370 is preferably formed of a metal, such as stainless steel. In any event, the tabs 374 are resilient in nature so that they can flex somewhat and apply an outward biasing force against the fix button 350 when inserted therein as described below. Since, the tabs 374 engage the fix button 350, the tabs 374 preferably are slightly angled (outwardly) relative to the bottom face of the base 372 to provide the desired biasing force. An upper face of the base 372 also includes a number of tabs, namely a plurality of tooth engaging tabs or fingers 376 that extend upwardly therefrom. The fingers 376 are also angled (similar to the angle of each tooth 316 on drive rod 310) relative to the upper face and are preferably formed on the base 372 near the central opening 373. The illustrated fingers 376 have tapered sides so that the upper portion of the fingers 376 has a width less than a width of the bottom portion of the fingers 376. The fingers 376 are angled inwardly toward one another and are arcuate in nature so that a top edge 377 thereof is slightly curved. When viewed from the top, the top edges 377 of the fingers 377 define a circular opening through which the drive rod 310 is permitted to pass.

The first tooth engaging member 370 is coupled to the fix button 350 by inserting it into the fix button 350 so that the retaining tabs 374 are positioned on an underside of the annular ring 366 of the fix button and apply an outward biasing force against the inner wall of the fix button 350 sufficient to retain and securely locate the first tooth engaging member 370 within the fix button 350. More specifically, the retaining tabs 374 are locked (wedged) into position between the underside of the ring 366 and the annular raised ring 369 so to be locked (snap fit) therebetween. In this fixed position, the fingers 376 extend up through the opening between the annular ring 366 and beyond the annular ring 366 but not necessarily beyond the first end 352 of the fix button 350. As will be described below, the fingers 376 serve to hold the drive rod 310 in a new position after it is advanced due to the interlocking meshing between the fingers 376 and one tooth 316.

The drive mechanism 300 also includes a press plug 380, best illustrated in FIGS. 14 and 14A, that acts to ratchet and advance the drive rod 310. The press plug 380 is an elongated member having a first end 381 and an opposing second end 382. The press plug 380 has a central bore 383 extending therethrough which is sized to receive and permit longitudinal travel of the drive rod 310. An outer surface 384 of the press plug 380 has a number of features formed therein and more specifically, a plurality of notches or recessed depressions or even openings 385 are formed therein and are radially spaced therearound. The exemplary features 385 are rectangular shaped openings. The outer surface 384 also has a number of longitudinal ribs or protrusions (e.g., rectangular shaped) 387 that are formed radially about the press plug 380 and are spaced apart from one another. The ribs 387 are located between the features 385 and the second end 382 (e.g., proximate the second end 382).

Near the first end 381, the press plug 380 has an increased diameter such that a shoulder 386 is formed and a planar ring-shaped platform 388 is formed with the bore 383 being centrally located relative thereto. At the first end 381, the press plug 380 includes a number of locking notches 389 (e.g., 2 notches) formed therein and extending to and being open at the first end 381. The locking notches 389 have shapes complementary to the locking tabs 360 of the fix button 350 as that they can receive the locking tabs 360 when the fix button 350 is orientated in a certain manner so that registration between the tabs 360 and notches 389 results. It will be appreciated that when the two are axially aligned, the interface between the fix button 350 and the press plug 380 is one where the first end 381 seats flush against the second end 354 of the fix button 350 when the button assembly 400 is activated and reaches it maximum point of travel as opposed to a rest position where a gap is formed between the two parts. Conversely, if the tabs 360 and the notches 389 are not in registration with one another, the tabs 360 contact and seat against the first end 381 of the press plug 380, thereby preventing the second end 354 of the fix button 350 from contacting the first end 381 of the press plug 380, which results is a space or gap of a predetermined distance being formed between the fix button 350 and the press plug 380. As will be described hereinafter in more detail, the orientation where the tabs 360 are received in the notches 389 is an unlocked position where the material 112 can be dispensed, while the orientation where the tabs 360 and notches 389 are not in alignment represents a locked position where the consumer is prevented from dispensing any applicator material 112. An inner surface of the press plug 380 includes a raised ring (bead) or flange 379 that is formed above the shoulder 386.

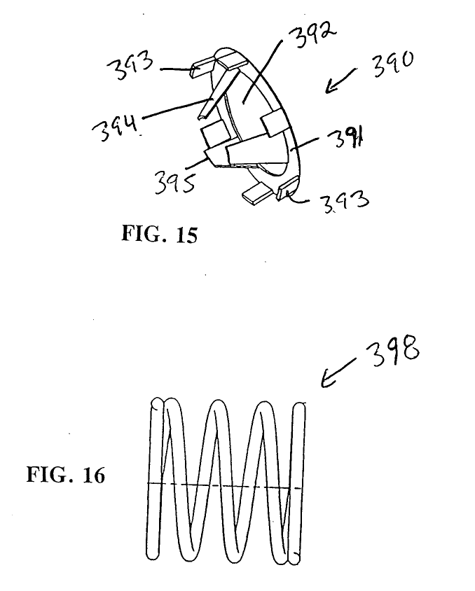

Turning now to FIG. 15, a second tooth engaging member 390 is illustrated and has some similarities to the first tooth engaging member 370 of FIG. 13. The second tooth engaging member 390 is coupled to the press plug 380 and engages the teeth 316 of the drive rod 310. One exemplary second tooth engaging member 390 includes a ring-shaped base 391 that has a central opening 392 formed therethrough and includes a plurality of retaining tabs 393 that extend from a peripheral edge of a top face of the base 391. The tabs 393 are radially spaced around the peripheral edge and can have any number of different shapes. Exemplary shapes include rectangular or square shaped. The second tooth engaging member 390 is preferably formed of the same material as the first tooth engaging member 370, e.g., stainless steel. The tabs 393 are thus resilient in nature so that they can flex somewhat and apply an outward biasing force against the inner wall of the press plug 380 when inserted therein as described below. Since, the tabs 393 engage the press plug 380, the tabs 393 preferably are slightly angled (outwardly) relative to the top face of the base 391 to provide the desired biasing force. An upper face of the base 391 also includes a number of tabs, namely a plurality of tooth engaging tabs or fingers 394 that extend upwardly therefrom and are concentrically arranged relative to the tabs 393 which are radially more outward than the fingers 394. The fingers 394 are also angled relative to the upper face and are preferably formed on the base 391 near the central opening 392. The illustrated fingers 394 have tapered sides so that the upper portion of the fingers 394 has a width less than a width of the bottom portion of the fingers 394. The fingers 394 are angled inwardly toward one another and are arcuate in nature so that a top edge 395 thereof is slightly curved. When viewed from the top, the top edges 395 of the fingers 394 define a circular opening through which the drive rod 310 is permitted to pass.

The second tooth engaging member 390 is coupled to the press plug 380 by inserting it into the press plug 380 so that the member 390 sits on the planar ring-shaped platform 388 and the bores 383, 392 are aligned to permit passage of the drive rod 310. The tabs 393 are snap fit or wedged between the annular ring 379 and the shoulder 386 of the platform 388 and this locks it in place. The tabs 393 apply a biasing force against the inner wall of the press plug 380 above the platform 388 and this force acts to hold and retain the member 390 relative to the press plug 380.

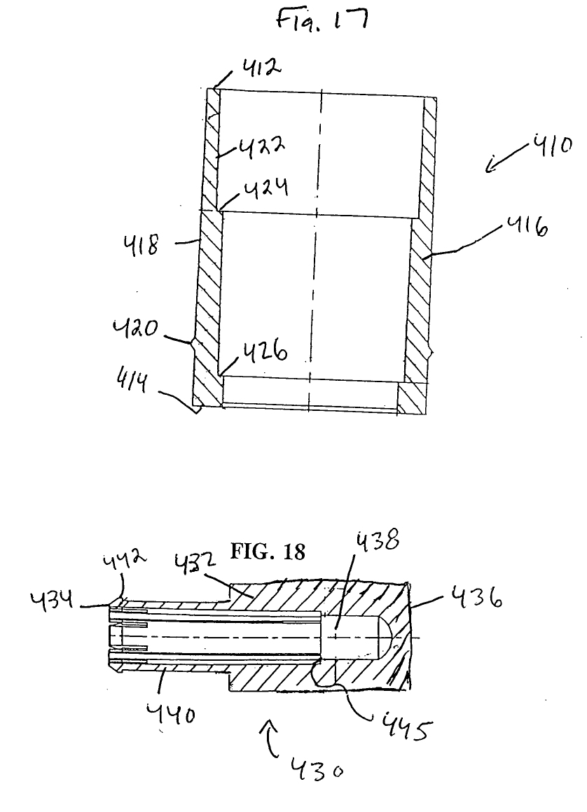

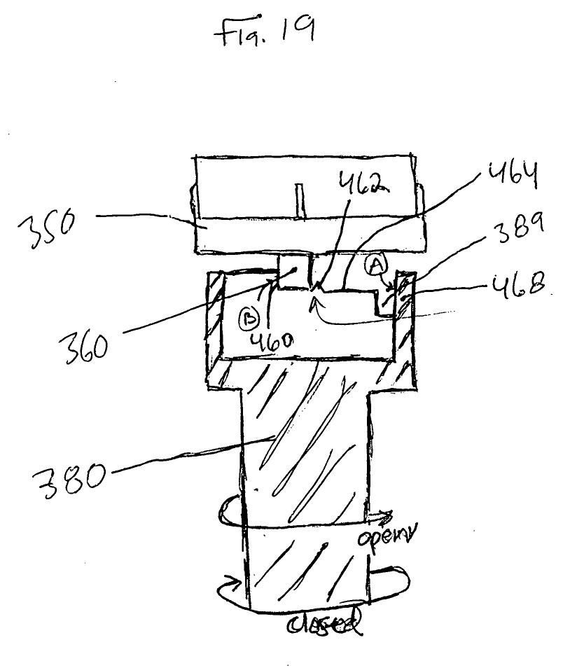

FIG. 16 shows a first spring 398 (coil spring) that has a central opening extending therethrough to permit passage of the drive rod 310 and is disposed between the fix button 350 and the press plug 380. More specifically, one end of the first spring 398 seats against an underside of the annular ring 366 of the fix button 350 and the opposite end of the first spring 398. The first spring 398 is thus biased between the fix button 350 and the press plug 380; however, the position of the fix button 350 is fixed within the body 110 and therefore the stored energy of the first spring 398 is translated into a biasing force being applied to the drive rod 310 to effectuate a return motion of the drive rod 310 in a direction toward the second end 116 of the body 110.

The button assembly 400 is configured to provide the consumer with an easy means or mechanism to advance the drive rod 310 in a ratcheted, incrementally controlled manner so that a small amount of applicator material 112 is dispensed upon each operative action by the consumer, e.g., pressing the button assembly once. The button assembly 400 is best shown in FIGS. 1 and 17-18.

FIG. 17 illustrates a lock plug 410 that serves as a means for securely coupling the button assembly 400 to the body 110. The lock plug 410 is essentially a hollow cylindrical member that has an open first end 412 and an opposing open second end 414. An outer cylindrical wall 416 of the lock plug 410 is slightly tapered in that the outer diameter of the first end 412 is slightly less than the outer diameter of the second end 414. An outer surface 418 of the wall 416 includes an annular ring or protrusion 420 that extends outward therefrom and is formed proximate the second end 414. The ring 420 has a shape that is complementary to the groove 129 formed along the inner surface 120 of the body 110 near the second end 116 thereof. The mating between the ring 420 and the groove 129 effectuates a snap-fit engagement between the lock plug 410 and the body 110 and also serves to properly locate and position the lock plug 410 within the body 110. When the lock plug 410 is locked in place within the body 110, the second end 414 of the lock plug 410 is aligned with the second end 116 of the body 110.

An inner surface 422 of the lock plug 410 also has a number of features formed as a part thereof. More specifically, the inner surface 422 includes a first annular shoulder 424 and a second annular shoulder 426, with the first annular shoulder 424 being closer to the first end 412 of the lock plug 410. The inner diameter of the second annular shoulder 426 is less than the inner diameter of the first annular shoulder 424. It will be appreciated that as shown in FIG. 1, the press plug 380 is received within and is permitted to move longitudinally relative to the lock plug 410. In other words, the inner cavity of the lock plug 410 accommodates the press plug 380 and in one embodiment, the first annular shoulder 424 limits the travel of the press plug 380 by acting as a stop. More specifically, the shoulder 386 of the press plug 380 seats against the first annular shoulder 424 in a relaxed rest position (non-actuated position). The biasing action of the first spring 398 against the press plug 380 also causes the press plug 380 to seat against the first annular shoulder 424 in a rest position.

The button assembly 400 also includes a button 430 or the like to permit the consumer to easily actuate the drive mechanism 300 and dispense product from its stored location in the body 110. The button 430 can be formed to have any number of different shapes and the manner of coupling the button 430 to the body 110 can likewise be varied; and therefore, it will be understood that the illustrated arrangement is merely exemplary. The button 430 generally includes a body 432 having a first end 434 that faces the body 110 and an opposing second end 436 that is contacted and pressed by the consumer. The body 432 can have any number of different shapes, e.g., cylindrical, square, oblong, etc. The body 432 has a bore 438 formed therein from the first end 434 to a location near but not to the second end 436. The bore 438 is dimensioned so that it can receive the second end 314 of the drive rod 310.

The body 432 includes a plurality of legs 440 that extend outwardly from the first end 434 thereof. Each leg 440 is preferably formed perpendicular to the first end 434 and includes a catch feature 442 formed at a distal end thereof. The illustrated catch feature 442 is a flange or hook shaped member that is configured to engage and couple the button 430 to the lock plug 410. In other words, the legs 440 are inserted into the opening formed through the lock plug 410 by bending the legs 400 inward so that the catch features 442 clear the second annular shoulder 426 of the lock plug 410. The notches 385 formed in the press plug 380 accommodate the legs 440 of the button 430 as the legs 440 are driven along the press plug 380 in a manner that permits the legs 440 to clear the second annular shoulder 426 of the lock plug 410.

The legs 440 are resilient in nature so that they can be inwardly flexed under force and then will return to their relaxed positions when the force is removed. As soon as the catch features 442 clear the second annular shoulder 426 and they are released, the biasing action of the legs 442 causes the catch features 442 to engage the second annular shoulder 426, thereby preventing the button 430 from simply falling out from the body 110. In this manner, the button 430 is coupled to the body 110, while at the same time, the button 430 can freely move relative thereto since the legs 440 can ride along the inner surface of the lock plug 410 upon a pressing action of the button 430. The button 430 also includes an annular shoulder 445 formed along the inner wall of the body 432 for providing a stop for the press plug 410.

It will be appreciated that the length of the legs 440 is variable and by increasing or decreasing the length of the legs 440, the distance between the first end 434 and the second end 116 of the body 110 is variable when the button 430 is in the rest position.

The button 430 locks and is orientated in a keyed position relative to the press plug 380 by mating male and female features thereof such that the button 430 and press plug 380 rotate together as one; however, the two can independently move longitudinally relative to one another. For example, the ribs 387 formed as part of the press plug 380 are receive within female grooves (not shown) that are formed along the inner bore of the button 430 and can extend along the inner surfaces of the legs 440. When the two complementary features mate together, the button 430 is keyed relative to the press plug 380 to permit the two parts 430, 380 to slide longitudinally relative to one another, while rotation between the two parts is prevented. The button assembly 400 also includes a second spring 450 (FIG. 1) that is disposed between the second end 116 of the body 110 and the button 430 to bias the button 430 in a rest position. It will be appreciated that other alternative locations can be provided for the spring 450.

The operation of the applicator pen 100 will now be described with reference to all of the figures. To actuate the applicator pen 100 and dispense a predetermined amount of applicator material 112, the button 430 is pressed inwardly. As the button 430 is pressed, the legs 440 (catch features 442 thereof) ride along the inner surface of the lock plug 410 until the second end 382 of the press plug 380 seats against the annular shoulder 445. As the user continues to press the button 430, the press plug 380 itself is moved toward the first end 114 of the body 110. This action causes the first spring 398 to further compress and store energy. The distance which the press plug 380 can move within the body 110 is carefully selected so that it results in the first and second tooth engaging members 370, 390 being disengaged from respective teeth 316 and engaging the next adjacent teeth 316 respectively. Since the fix button 350 is held stationary in body 110 and cannot be advanced further towards the first end 114 of the body 110, the degree of travel of the press plug 380 is limited by the fix button 350. Thus, the press plug 380 can only be driven the distance between the first end 381 of the press plug 380 and the second end 354 of the fix button 350 when they are in a rest position. This distance is selected so that it is greater than a height of one tooth 316 and therefore, when the press plug 380 is advanced this distance, the fingers 394 of the second tooth engaging member 390 are disengaged from one tooth 316 (starting tooth) and brought into engagement with a tooth 316 that is immediately below the one tooth 316 (starting tooth). Simultaneously, the fingers 376 of the first tooth engaging member 370 are disengaged from one tooth 316 (starting tooth) and brought into engagement with a tooth 316 that is immediately below the one tooth 316 (starting tooth). As previously mentioned, the fingers 376 of the first tooth engaging member 370 serves to hold the drive rod 310 in a new advanced position after the button 430 is pressed and the drive rod 310 is driven its prescribed distance within the body 110. In this manner, the drive rod 310 is advanced in a ratcheted manner due to the pressing action of the button 430.

Once the drive rod 310 is driven the prescribed distance within the body 110 and has reached the end of its travel, the first spring 398 releases its stored energy and this is translated into a biasing force against the press plug 380. This results in the press plug 380 being driven back towards the second end 116 of the body 110 to its rest position. Since the product 112 is disposed above the plunger 330, which is connected to the drive rod 310, the advancement of the drive rod 310 is directly translated into the plunger 330 moving an incremental distance along the inner surface 120 of the body 110, thereby forcing the product 112 into the applicator assembly 200 such that a small amount is discharged through ports 228. If the user desires additional product 112 to be discharged, the user simply needs only to press the button 430 again and the above process is repeated with the drive rod 310 being advanced another one increment (one tooth increment) toward the first end 114 of the body 110.

If the optional locking mechanism is used, then the user first needs to rotate the button 430 to a preselected position where the locking tabs 360 and notches 389 align and mate with one another. Once this occurs, the press plug 380 has the necessary degree of movement to cause a ratcheting action which results in the drive rod 310 being advanced toward the first end 114 of the body 110. Since the product 112 is disposed above the plunger 330, which is connected to the drive rod 310, the advancement of the drive rod 310 is directly translated into the plunger 330 moving an incremental distance along the inner surface 120 of the body 110, thereby forcing the product 112 into the applicator assembly 200 such that a small amount is discharged through ports 228. To lock the applicator 100, the button 430 is simply rotated until the locking tabs 360 become disengaged from the notches 389 under the biasing action of the first spring 398 against the press plug 380.

FIG. 19 is an enlarged partial cross-sectional view illustrating the interaction between the fix button 350 and the press plug 380. More specifically, the vertical wall of the press plug 380 in which notch 389 is configured to facilitate the travel of the locking tab 360 between a locked and unlocked position. The vertical wall includes a first stop 460 in the form of a vertical cut in the wall and in the locked position, the tab 360 seats against the first stop 460 and is retained in the locked position by a bump 462, whereby the tab 460 is wedged between the first stop 460 and the bump 462. As previously mentioned, to unlock the applicator pen 100, the press plug 380 is rotated (as a result of rotation of the button 430 about 90 degrees) causing the tab 360 to clear the bump 462. Once the tab 360 clears the bump 462, the tab 360 is free to travel along a ledge 464 until the tab 360 falls into the notch 389. A vertical wall 468 that defines apart of the notch 389 acts as a second stop and ensures axial alignment between the tab 360 and the notch 389 and permits the tab 360 to be received in the notch 389 when the button 430 is pressed and the press plug 380 is moved longitudinally.

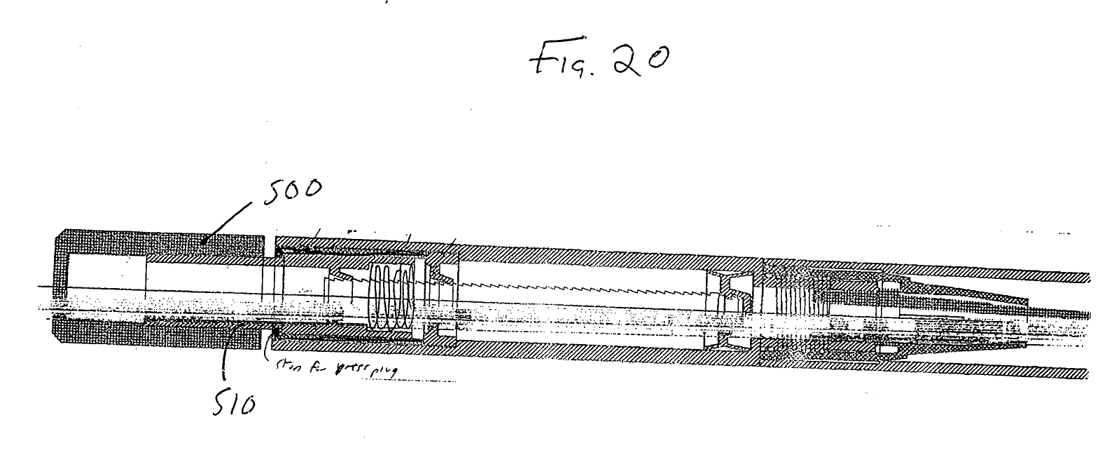

FIG. 20 is a view of another method of securely attaching a button to the body of the applicator pen. In this embodiment, a button 500 includes either male or female features formed along an inner surface of a bore formed therethrough. These features of the button 500 engage and mate with complimentary female or male features that are formed along an outer surface of a press plug 510. The press plug 510 can be otherwise identical to the press plug 380 described hereinbefore.

It will be appreciated by persons skilled in the art that the present invention is not limited to the embodiments described thus far with reference to the accompanying drawings; rather the present invention is limited only by the following claims.

1. An applicator pen comprising:
a body including a space for storing a material to be dispensed;
an applicator assembly coupled to one end of the body for dispensing a prescribed amount of the material;
a drive mechanism interacting with the stored material for causing the prescribed amount of material to be dispensed through the applicator assembly, the drive mechanism including a drive rod; and
a button assembly coupled to another end of the body and the drive mechanism, the button assembly being positionable between a rest position and an engaged position where the drive rod is ratcheted an incremental distance resulting in the stored material being directed towards the applicator assembly where the prescribed amount of material is dispensed therethrough.

2. The applicator pen of claim 1, wherein the drive rod is an elongated members have a plurality of teeth formed along a length thereof.

3. The applicator pen of claim 1, wherein the drive mechanism includes a plunger that is securely and lockingly coupled to one end of the drive rod and is disposed in the body such that it sealingly contacts an inner surface of the body, whereupon activation of the button assembly causes the plunger to slide along the inner surface.
